(19) United States
(12) Patent Application Publication
(10) Pub. No.: US 2006/0007144 A1
(43) Pub. Date: Jan. 12, 2006

(54) Joystick arrangement

(75) Inventors: Ken Allan Mathiasen, Soenderborg (DK); Jesper Bloch Olsen, Nordborg (DK)

Correspondence Address: MCCORMICK, PAULDING & HUBER LLP, CITY PLACE II, 185 ASYLUM STREET, HARTFORD, CT, 06103, US

(73) Assignee: Sauer-Danfoss ApS, Nordborg (DK)

(21) Appl. No.: 11/138,710

(22) Filed: May 26, 2005

(30) Foreign Application Priority Data
May 29, 2004 (DE) 10 2004 026 456.2

(51) Int. Cl. G09G 5/08

(52) U.S. Cl. 345/161

(57) ABSTRACT

The invention concerns a joystick arrangement (1) with a basic unit (3) and a movable handle unit (2), which comprises at least one electrical function element (15) with an energy supply connection and an endpoint of a wireless signal transmission path. It is endeavoured to simplify the mounting. For this purpose, the energy supply connection is connected with a power receiver (16) located in the handle unit (2), which power receiver (16) can be supplied with energy via a wireless power transmission path (20).

The invention concerns a joystick arrangement with a basic unit and a movable handle unit, which comprises at least one electrical function element with an energy supply connection and an endpoint of a wireless signal transmission path.

Such a joystick arrangement is known from U.S. Pat. No. 6,550,562 B2. Via three wires, the electrical function element is connected with a control device in the basic unit. The three wires comprise voltage, mass and a serial data transmission wire. The data transmission can also be wireless.

Such joystick arrangements are frequently used for controlling hydraulic machines. By moving the handle unit, which can also be called handle, hydraulic motors, for example piston-cylinder units, are activated in a desired direction, the activation of the handle unit in relation to the basic unit usually also being able to influence the speed, at which the motor works. The motors, for example, serve the deflection of an arm on a digger, the lifting of the load arm of a fork lift or the driving of the machine, when a self-propelled driven machine is concerned.

Further, such a handle unit has additional function elements in the form of buttons, switches, wheels etc., with which the operator can control further functions. While the activation of the handle unit in relation to the basic unit can usually be determined by a sensor arrangement, which is integrated in the basic unit, these signals from the additional function element or elements have to be transmitted to an evaluation system.

When mounting a joystick arrangement, it is necessary, also when a wireless signal transmission path is used, to ensure that the electrical function element is supplied with the required electrical energy. For this purpose, it is necessary to create an electrical wire connection before the mounting, which should then be as invisible as possible, when the handle unit is mounted on the basic unit. This means that the installer will have to be rather skilled to perform the mounting.

The invention is based on the task of simplifying the mounting.

With a joystick arrangement as mentioned in the introduction, this task is solved in that the energy supply connection is connected with a power receiver located in the handle unit, which power receiver can be supplied with energy via a wireless power transmission path.

With this embodiment no electrical wires are required at all to create a connection between the basic unit and the electrical function element. It is sufficient to mount the handle unit mechanically on the basic unit, that is, to connect it with the basic unit or otherwise locate it near the basic unit. The energy, for example electrical energy, which is required for the operation of the function element, is transmitted wirelessly, so that here electrical wires are dispensable. Within certain limits, a wireless energy transmission is possible without problems. Particularly, when the electrical energy consumption of the electrical function element is limited, such an energy transmission can be realised in a wireless manner without large efforts.

It is preferred that the energy transmission path has a high frequency band. With a high frequency field, electrical energies can be transmitted over certain distances with a relatively good efficiency. The term “high frequency field” is here used in a rather wide sense. It reaches from approximately 100 KHz to 20 MHz. The higher the frequency is, the more power can be transmitted. The energy can also be transmitted with light; also a “Bluetooth” technique could be imagined.

The energy can also be transmitted in other ways, for example acoustically or by pressure. In this case, an energy conversion into electrical energy is provided in the handle unit.

Preferably, a power transmitter is located in the basic unit. In this case, the power transmission path is automatically kept short, that is, the spatial distance between the power transmitter and the power receiver remains small. Particularly with higher frequencies, this embodiment keeps the risk of interferences, which could penetrate to the environment, small. Further, the efficiency of the power transmission is increased.

Preferably, the power receiver has an energy accumulator, for example a battery or a capacitor. In a manner of speaking, the battery or the capacitor serves as energy buffer for periods, in which the power transmission via the wireless power transmission path is disrupted, meaning that the electrical power cannot be transmitted with the required intensity. During normal operation, the battery can be constantly charged, so that it is ensured that the required electrical power is constantly available.

Preferably, the electrical function element is connected with a circuit in the handle unit, which has a permanent, variable memory. In this memory, data can thus be stored, which would then not be lost during a malfunction or a failure of the electrical power transmission. For example, certain operation parameters can be stored in the memory, which are sized for the individual machine. When the machine is turned off, the power transmitter will no longer transmit. However, the operation parameters will be maintained. This store can also be used for simplifying the mounting. In a manufacturing step prior to the final mounting, the handle unit can be supplied with the required parameters, or with programs, which are favourable for the control of the machine. When, then, the handle unit is mounted on the basic unit, the programs or data for the operation of the machine are available right away. An update can easily be made in that the handle unit is replaced by another handle unit with new data or programs.

Preferably, the signal transmission path has a second end point, which is connected with a bus interface. Thus, it is possible to connect the electrical function element directly with a bus, for example a CAN-bus, which is located on the machine. This is particularly advantageous, when the machine is a self-propelled driven machine, as the use of CAN-busses is common in vehicles. Thus, via the joystick it is possible to intervene in practically the complete system of the vehicle or the machine.

Preferably, the handle unit is detachably connected with the basic unit. The connection can, for example, be realised by means of a snap or a catch connection. Also some kind of bayonet connection is possible. If required, easily activated, auxiliary connecting parts can be used, for example a flap or a union nut. When the handle unit is detachably connected with the basic unit, a number of advantages occur, which will be described below.

For example, the basic unit is optionally connected with one of several handle units, which have different embodiments. The users often want a handle unit with special buttons, scroll buttons, adjustment wheels, switches or the like, a special location of these activation elements or the like. This is easily realised with the detachable connection of the handle unit on the basic unit. In each case, the signal and energy transmission can have the same embodiment, namely wireless. In order to be able to adapt to the wishes of a user, it is sufficient to use a handle unit, which has the corresponding external design.

It is also advantageous, when the basic unit is optionally connectable with one of several handle units, in which the individual electrical function elements have different characteristics. For example, in connection with the activation of an activation arrangement, which releases or controls the electrical function element, different response times or different ramp functions or other different responses can be built in. The user can then have a handle element, which is adapted to him and satisfies his wishes.

It is particularly advantageous, when driver-specific data are stored in at least one handle element, said data being automatically transferable to the basic unit when mounting the handle unit. These driver-specific data can, for example, be the response times or the functions mentioned above. However, also seat positions or similar things on the vehicle can also be stored in the handle unit. Each driver then has his own handle unit. When the driver mounts his handle unit on the basic unit, the vehicle or the driven machine is automatically adjusted in accordance with his programmed settings, for example, the seat position can be set correctly, the chair back inclination of the seat can be set accordingly, the position of the driving mirrors can be set, etc. Additional measures are not required. It is sufficient, when the driver mounts his handle unit on the basic unit.

It is also advantageous, when at least one electrical function element has a theft protection function, which can only be deactivated, when a handle unit is mounted. When the machine is, for example, a tractor, the driver can take along the handle unit when leaving the tractor, thus ensuring that the tractor is theft protected. For example, a starter killer is activated, so that the motor of the tractor can no longer be started.

It is also advantageous, when the basic unit is detachably mounted on a vehicle or a driven machine. Then, a remote control can be realised in a simple manner. The basic unit merely has to be detached from the machine or the vehicle. The driver can then position himself outside the machine and then possibly has a better view of the functions to be performed by the machine.

Preferably, at least one additional basic unit is provided, and the handle unit communicates optionally with one of the basic units. In this case, the vehicle or the driven machine can be controlled from different locations. For example, it can then be ensured that the machine is stopped, when the handle unit is removed from a basic unit. The machine then cannot be operated again, until the handle unit communicates with another basic unit. It may even be ensured that the handle element causes other reactions, depending on the location of the basic unit. For example, the posture of the operator can be considered. When sitting, an operator will handle the handle unit differently than when standing.

It is also advantageous that the handle unit has a display. Such a display can, for example, be a liquid crystal display (LCD display). In this display, also buttons or contact sensitive spots can be imagined, which can then be reconfigured by the user to different functions, as it is, for example, known from mobile phones. It is also possible to provide light in the function elements, for example, buttons or switches, so that the light is turned on, when a button or a switch is activated.

Preferably, the function element can be configured via the signal transmission path. Then, the function element can, for example, be adapted to different vehicles or driven machines, in which connection it is of course possible to consider previously stored user-specific settings.

In the following, the invention is described on the basis of a preferred embodiment in connection with the drawings, showing:

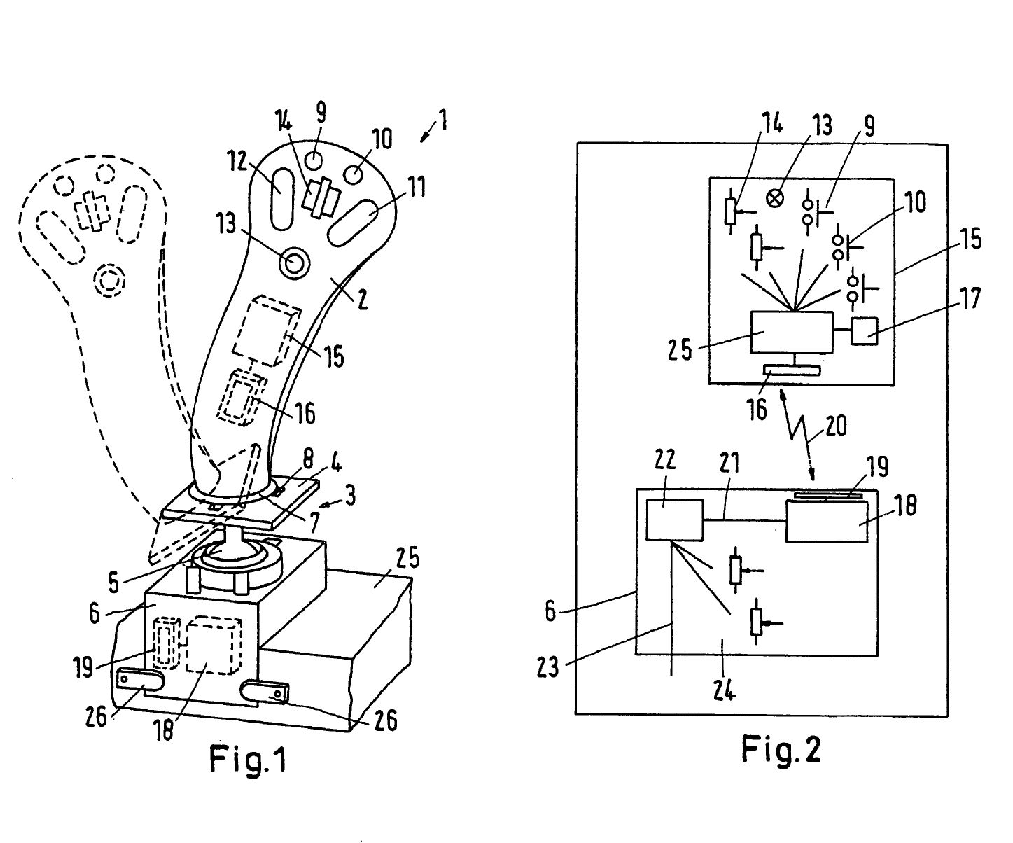

FIG. 1 a schematic view of a joystick arrangement

FIG. 2 a block schematic diagram

A joystick arrangement 1 has a handle unit 2, which is detachably fixed on a basic unit 3. For this purpose, the basic unit 3 has a mounting plate 4, which is supported on a housing 6 via a ball joint, so that the handle unit 2 can be displaced from the position shown with full lines to a position which is shown with dotted lines. Shown is a displacement in one direction, in fact, however, the handle unit 2 can be displaced in random directions in relation to the housing 6.

The mounting plate has a mounting opening 7, into which the handle unit 2 can be inserted. Distributed around the mounting opening 7 are several radially extending recesses 8, into which radial pins, not shown in detail, on the handle unit 2 can engage, when the handle unit 2 is mounted. After inserting the handle unit 2 into the mounting plate 4, the handle unit 2 must be turned, for example by 45°, in relation to the mounting plate 4 to ensure a safe fixing. Thus, the handle unit 2 is detachably fixed on the basic unit 3, here with some kind of bayonet connection. Other kinds of mounting, for example with a union nut or the like, are possible.

In a manner not shown in detail, the mechanical fixing between the handle unit and the basic unit can even be omitted. The handle unit can be moved freely in the room. This can now be compared with a computer mouse, which is, however, only movable in two dimensions. The opportunity of moving the handle unit freely in the room gives a further comfort feature. It is merely required that the handle unit and the basis unit can communicate with each other.

By displacement in relation to the housing 6, the handle unit 2 controls a number of functions of a hydraulic machine, which is not shown in detail. The machine can be provided with several drives. A displacement of the handle unit 2 in relation to the housing 6 in one direction will activate a drive in one direction or the other, depending of the displacement direction. The degree of the deflection is a measure for the power, with which the drive is activated, for example a measure for an extension movement of a piston-cylinder arrangement or a measure for the speed, at which a rotary motor is activated. As the handle unit 2 can be displaced in several directions in relation to the housing 6, it is also possible to control more than one motor, for example two motors.

The handle unit 2 has a number of additional actuation elements, namely two buttons 9, 10, two switches 11, 12, and adjustment wheel 14 and a light emitting diode 13. The location shown here is merely an example. Different users have different wishes. The mentioned actuation elements 9 to 14 are connected with an electrical function element 15, which can, for example, have the form of an integrated circuit. The function element is connected with an antenna 16, which is able to derive energy from a high frequency field. The high frequency field, which is explained below, works in the area from 100 KHz to approximately 20 MHz. Preferred frequencies are, for example, 125 KHz or 13 MHz. In a manner not shown in detail, the function element 15 can have an A/D converter, a micro-processor, a RAM, an EEPROM, a ROM, oscillators, timers and counters. Also a multiplexer is possible, when several actuation elements 9 to 14 are connected to the function element 15. The function element 15 can, for example, be a component group MLX10111 of the Melexis Microelectronic Systems, Concord N.H., USA.

In a manner not shown in detail, the handle unit can also have a display, for example an LCD display. This display may be provided with contact sensitive areas, via which a user can enter different functions or which he can reconfigure to different functions. The use of the handle unit thus gets very flexible.

As can be seen from FIG. 2, the function element can further have a battery 17, so that a brief failure of the power transmission can be buffered via the high frequency field.

The function element 15 is switchable. On the one hand, the high frequency field can be operated with 13 MHz, on the other hand also with 125 KHz. In each case, it is ensured that the required electrical power can be transmitted.

The electrical power is provided by a power transmitter 18, which is located in the housing 6. The power transmitter 18 is connected with an antenna 19. The antenna 19 can also be integrated in the power transmitter 18. Via the antenna 19, the power transmitter emits the high frequency field, which is used to transfer the electrical power to the function element 15.

The power transmitter 18 can, for example, be a component group MLX90121 of Melexis Microelectronic Systems.

As appears from FIG. 2, a wireless transmission path 20 is provided between the function element 15 and the power transmitter 18. Via this path 20, not only the electrical power is transferred, which is required for driving the function element 15, but the transmission path 20 is also used to transfer the signals, which are generated by the function element 9 to 14, to the housing 6. For this purpose, the power transmitter 18 has a data receiving arrangement. The function element 15 is able to send and receive data.

Instead of an electrically higher frequent field, the required energy can also be transferred in a different manner, for example by means of light. For this purpose, light emitting diodes and corresponding light receivers, for example light sensitive transistors, would be available. Also an energy transfer in an acoustic manner or low-frequent would be possible. Also a “Bluetooth” technology could be imagined, so that in principle a larger distance between the handle unit 2 and the basic unit 3 would be acceptable. Bluetooth works in the Gigahertz area.

In any case, some sort of security would be built into the communication between the handle unit 2 and the basic unit 3, so that the certainty for discovering the determination of a “false” signal is 100 percent. Such a signal might trigger an error situation. The security can be ensured by way of hardware. However, it is also possible to ensure it by means of software.

When such a non-electrical transmission path is available, it is of course possible not only to transfer the energy, but also the signals, via this transmission path. In this case, an energy converter will be required, which converts the non-electrical signals into electrical signals and vice versa.

The power receiver 18 is connected via a serial bus 21 with a bus interface 22, which again is connected with a CAN-bus 23. When the joystick arrangement is mounted on a vehicle, it gives direct access to the CAN bus and thus to practically all component groups of the vehicle, which are connected with the CAN bus.

For the sake of completeness it is mentioned that the housing 6 has an energy supply 24, which, for example, supplies the power transmitter 18.

As appears from FIG. 1, not only the handle unit 2 is detachable from the basic unit 3. Also the basic unit 3 is detachably mounted on a frame 25, the frame 25 being, for example, part of a vehicle. When the basic unit 3 with the handle unit2 is removed from the frame 25, it is, in a manner of speaking, possible to remote-control the vehicle or machine to be controlled. Safety levers 26 serve the purpose of fixing the basic unit in the frame 25. Plug connections, not shown in detail, ensure that the energy supply 24 and the CAN-bus 23 are connected with the basic unit 3, when the basic unit 3 is inserted in the frame 25.

The embodiment shown gives a number of advantages.

Even when the handle unit 2 is not detachably mounted on the basic unit 3, the mounting is substantially easier, as no electrical connections have to be established.

However, additional advantages are involved, when the handle unit 2 is detachably mounted on the basic unit 3. For example, several handle units 2 can be provided, which are provided with different arrangements of actuating elements 9 to 14. Many users want a handle unit with special buttons or switches or a special location of the buttons, and with the idea described here, this is possible in a simple and cost effective manner.

With the handle unit, it is possible to communicate with the whole machine via the CAN-bus. Particularly when used in a vehicle, there are many possibilities. Finally, not only interventions in the actuation of hydraulic motors are possible, but also, for example, in the injection into a diesel engine driving a pump, which is provided for the supply of hydraulic consumers. Thus, the joystick arrangement extends its application field.

When, now, the handle unit 2 can be dismounted from the basic unit 3, the handle unit 2 can be taken along, when leaving a self-propelled driven machine, the driven machine then being theft-protected (starter kill) and locked. When returning to the driven machine, the handle unit 2 is inserted in the basic unit 3 again, and the machine is ready to work.

Each user can be provided with his own special handle unit 2, in which his specific data are stored, for example, seat position, driving mirror position, speed profile and the like. When, now, the driver or operator inserts the handle unit 2 into the basic unit 3, the machine is automatically loaded with his desired settings.

It is possible, initially to provide at least one additional basic unit on the vehicle or on the driven machine. The handle unit 2 can then removed from the first basic unit 3 and be fixed on or connected with the additional basic unit 3. Here it can be imagined that the complete system blocks the basic unit 3 at the same time, when the handle unit is removed, so that an undesired actuation is not possible at all, also when an undesired actuation takes place in the basic unit. When the handle unit is then mounted in the other basic unit, specific settings can also exist here.

In connection with new software actualisations the manufacturer could deliver a new handle unit 2. When mounted in the basic unit 3, a software actualisation would then take place, which can easily comprise the whole machine or the whole vehicle, respectively, as a connection from the handle unit 2 to the CAN-bus of the machine or the vehicle exists via the wireless transmission path 20.

Also an upload to the handle unit 2 is possible, so that a certain function element on the handle unit 2 can be provided with a new function via the transmission path 20.

1. A joystick arrangement with a basic unit and a movable handle unit, comprising at least one electrical function element with an energy supply connection and an endpoint of a wireless signal transmission path, wherein the energy supply connection is connected with a power receiver located in the handle unit, which power receiver can be supplied with energy via a wireless power transmission path.

2. The arrangement according to claim 1, wherein the energy transmission path has a high frequency field.

3. The arrangement according to claim 1, wherein a power transmitter is located in the basic unit.

4. The arrangement according to claim 1, wherein the power receiver has an energy accumulator, for example a battery or a capacitor.

5. The arrangement according to claim 1, wherein the electrical function element is connected with a circuit in the handle unit, which has a permanent, variable memory.

6. The arrangement according to claim 1, wherein the signal transmission path has a second end point, which is connected with a bus interface.

7. The arrangement according to claim 1, wherein the handle unit is detachably connected with the basic unit.

8. The arrangement according to claim 7, wherein the basic unit is optionally connected with one of several handle units, which have different embodiments.

9. The arrangement according to claim 7, wherein the basic unit is optionally connectable with one of several handle units, in which the individual electrical function elements have different characteristics.

10. The arrangement according to claim 8, wherein driver-specific data are stored in at least one handle element, said data being automatically transferable to the basic unit when mounting the handle unit.

11. The arrangement according to claim 7, wherein at least one electrical function element has a theft protection function, which can only be deactivated, when a handle unit is mounted.

12. The arrangement according to claim 1, wherein the basic unit is detachably mounted on a vehicle or a driven machine.

13. The arrangement according to claim 1, wherein at least one additional basic unit is provided, and the handle unit communicates optionally with one of the basic units.

14. The arrangement according to claim 1, wherein the handle unit has a display.

15. The arrangement according to claim 1, wherein the function element can be configured via the signal transmission path.
